(19) United States
(12) Patent Application Publication
(10) Pub. No.: US 2025/0211820 A1
(43) Pub. Date: Jun. 26, 2025

(54) Presenting Supplemental Content With Paused Video

(71) Applicant: GOOGLE LLC, Mountain View, CA (US)

(72) Inventors: Joseph Joseph Cherukara, San Francisco, CA (US); Michael Sun, San Francisco, CA (US); Rachel Mary Pyrdol, San Francisco, CA (US); Shweta Agrawal, San Jose, CA (US); Pramodh Ankit Devagi, Mountain View, CA (US)

(21) Appl. No.: 19/020,741

(22) Filed: Jan. 14, 2025

Related U.S. Application Data
(63) Continuation of application No. 18/956,836, filed on Nov. 22, 2024.
(60) Provisional application No. 63/614,166, filed on Dec. 22, 2023.

(51) Int. Cl. H04N 21/431; H04N 21/472

(52) U.S. Cl. CPC H04N 21/4316; H04N 21/472

(57) ABSTRACT

A method, performed by a server in communication with a user device via a network, includes receiving one or more signals including at least one signal indicative of interest or attention of a user of the user device, and identifying one or more supplemental content items. The method also includes, based on the one or more signals, causing the user device to, responsive to detecting an indication of a pause event while a video content item is presented in a video player on a display associated with the user device, present on the display the one or more supplemental content items with the paused video content item.

### CROSS-REFERENCE TO RELATED APPLICATIONS

This is a continuation of U.S. patent application Ser. No. 18/956,836, filed on Nov. 22, 2024, which claims the benefit of U.S. Provisional Patent Application No. 63/614,166, filed on Dec. 22, 2023. The disclosure of each of the above-identified applications is hereby incorporated herein by reference in its entirety.

### FIELD OF TECHNOLOGY

The present disclosure relates to presenting content and, more specifically, to presenting supplemental content items with a paused video content item.

### BACKGROUND

When a user watches a video (e.g., via a web browser or mobile application), the user is often presented with supplemental content items (e.g., an advertisement, or other content that supplements the video being watched). Existing systems present these supplemental content items in various ways. For example, some existing systems present supplemental content items during scheduled breaks. However, the user may find such scheduled breaks to be disruptive, resulting in a dissatisfactory user experience. The user may be less likely to view or pay attention to the supplemental content items, which may in turn negatively impact selection or conversion rates (e.g., in the scenario where the supplemental content items are ads). Other existing systems present supplemental content items in a location showing the next video to be played. However, the user would see the supplemental content items only by scrolling to the location showing the next video, which may decrease the likelihood that the user sees the supplemental content items. Further, the user may mistakenly associate the supplemental content item with the video. Such confusion may lead to an unpleasant user experience and low interaction (e.g., conversion) rates for the supplemental content items.

Moreover, existing systems fail to take into account indications of a user's interests or attention when pausing a video. For example, some users who pause a video do so because they are taking a break from their computer, while others do so because they wish to research a topic relevant to the video being shown, or wish to examine something being shown in the video more closely, etc. Because existing systems are agnostic to the user's interest or attention, those systems are more likely to provide supplemental content items that the user will not see and/or pay attention to, thereby wasting processing and/or communication resources and causing a more disruptive/negative user experience.

### SUMMARY

In one example implementation, a method for, performed by a user device, for dynamic reconfiguration of a video player when pausing a video content item, comprises: playing the video content item in the video player while the video player is arranged in a first region of a display associated with the user device; detecting an indication of a pause event; responsive to the indication of the pause event, pausing the video content item, rearranging the video player to be in a second region of the display that is smaller than the first region, and presenting one or more advertisements in one or more respective content slots of the display that do not overlap the second region.

In another example implementation, a user device comprises one or more processors; and a non-transitory memory storing executable instructions thereon. The instructions, when executed by the one or more processors, cause the one or more processors to: play a video content item in a video player while the video player is arranged in a first region of a display associated with the user device; detect an indication of a pause event; responsive to the indication of the pause event, pause the video content item, rearrange the video player to be in a second region of the display that is smaller than the first region, and present one or more advertisements in one or more respective content slots of the display that do not overlap the second region.

In another example implementation, a method, performed by a server in communication with a user device via a network, comprises: receiving one or more signals including at least one signal indicative of interest or attention of a user of the user device; identifying one or more supplemental content items; and based on the one or more signals, causing the user device to: responsive to detecting an indication of a pause event while a video content item is presented in a video player on a display associated with the user device, present on the display the one or more supplemental content items with the paused video content item.

In another example implementation, a server in communication with the user device via a network, comprises: one or more processors; and a non-transitory memory storing executable instructions thereon. The executable instructions, when executed by the one or more processors, cause the one or more processors to: receive one or more signals including at least one signal indicative of interest or attention of a user of the user device; identify one or more supplemental content items; and based on the one or more signals, cause the user device to: responsive to detecting an indication of a pause event while a video content item is presented in a video player on a display associated with the user device, present on the display the one or more supplemental content items with the paused video content item.

### BRIEF DESCRIPTION OF THE DRAWINGS

FIG. 1 is a block diagram of an example system in which techniques for presenting supplemental content items with a paused video content item can be implemented.

FIGS. 2A-2F depict example scenarios in which supplemental content items are presented with a paused video content item, according to some implementations.

FIGS. 3A-3B depict example processes for presenting supplemental content items with a paused video content item, according to some implementations.

FIG. 4 is a flow diagram of an example method for dynamic reconfiguration of a video player when pausing a video content item, according to one implementation.

FIG. 5 is a flow diagram of an example method for presenting supplemental content items with a paused video content item, according to one implementation.

### DETAILED DESCRIPTION OF THE DRAWINGS

This disclosure provides methods and systems for presenting, to users watching video content, supplemental content in a manner that conserves processing and/or communication (network) resources and is relatively non-intrusive and non-disruptive to the user. In particular, the disclosure relates to whether and/or how supplemental content item(s) are provided when a user pauses a video.

As used herein, the term “supplemental content item” refers to an item of content that supplements primary content (specifically, a video content item) being watched and/or paused by a user, such as a digital advertisement, or comments, etc. Supplemental content items may be presented proximate to the primary content, or as an overlay, etc., unless a more specific presentation format is indicated.

As used herein, the term “sponsor” refers to a party that owns, generates, provides, authorizes use of, etc., a supplemental content item. For example, the sponsor may be a merchant selling a product or service associated with a digital advertisement. The sponsor may buy a content slot to present a digital advertisement of the sponsor's product or service.

In one aspect, a user device detects an indication of a pause event (e.g., detects a user's selection of a virtual pause button of a video player). In some implementations, responsive to the indication of the pause event, the user device pauses the video, decreases the size of the video player, and presents one or more supplemental content items in respective content slots proximate to the smaller video player. Advantageously, presenting supplemental content items nearby (not overlaid on) the video when a user pauses the video can provide a less intrusive user experience by avoiding obfuscation of the video, which the user may still wish to view or reference despite the pause event. Moreover, presenting supplemental content items proximate to a resized video player is less likely to mislead the user by causing the user to associate the supplemental content items with the video. Further, the limited space on a user's display is more efficiently utilized. For example, the total space (or “real estate”) of the user's screen inhabited by the shrunken video player may be no larger than the space that was inhabited by the video player prior to pausing the video.

In another aspect, a server receives one or more signals (e.g., from the user device and/or other internal or external sources) and, based on the signal(s), causes the user device to present one or more supplemental content items responsive to an indication of a pause event. Advantageously, this provides a better user experience by presenting supplemental content items when the user is more likely interested in viewing, or more likely to pay attention to, that supplemental content (thereby mitigating unwanted disruptions to the user's experience), and reduces the use of processing and/or communication resources by not providing/presenting content that users will simply ignore. In some implementations, the system determines the user's interests or attention using a machine learning model. In this way, the system may determine the user's interests or attention quickly and accurately, and present (or not present) supplemental content items in a non-disruptive way based on the determination.

### Example Computing System

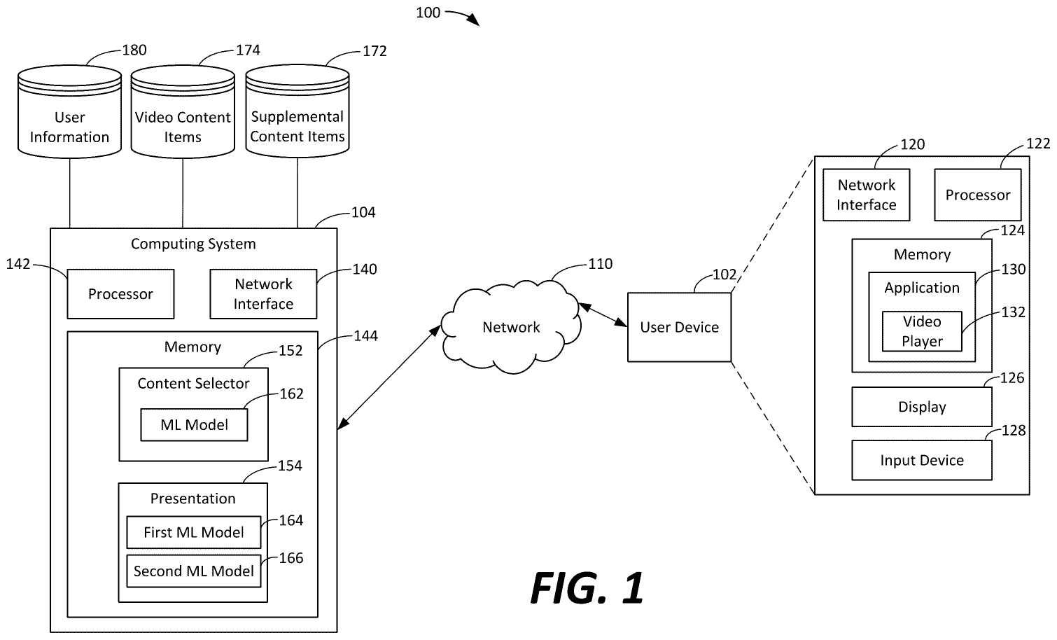

FIG. 1 illustrates an example system 100 in which one or more techniques for presenting supplemental content items when pausing a video content item may be implemented. The example system 100 includes a user device 102, a computing system 104, and a network 110. The computing system 104 is remote from the user device 102, and communicatively coupled to the user device 102 via the network 110.

The network 110 may be a single communication network (e.g., the Internet), and in some implementations also includes one or more additional networks. As just one specific example, the network 110 may include a cellular network, the Internet, and a server-side local area network (LAN). While FIG. 1 shows only a single user device 102, it is understood that the system 100 may include any suitable number of similar user devices operating according to the principles disclosed herein.

The user device 102 is generally configured to receive and play content, including video content, received via the network 110. The user device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the user device 102 includes a network interface 120, a processor 122, and memory 124. The user device 102 further includes or is associated with a display 126 and an input device 128.

The processor 122 may be a single processor (e.g., a central processing unit (CPU)), or may include a set of processors (e.g., multiple CPUs, or one or more CPUs and one or more graphics processing units (GPUs)). Although the display 126 is depicted as part of the user device 102, it is understood that the display 126 may be external to the user device 102 and communicatively connected to the user device 102 with wires and/or the network 110.

The memory 124 includes one or more computer-readable, non-transitory storage units or devices, which may include persistent (e.g., hard disk) and/or non-persistent memory components. The memory 124 stores instructions that are executable by the processor 122 to perform various operations, including the instructions of various software applications and the data generated and/or used by such applications. In the example implementation of FIG. 1, the memory 124 stores at least an application 130, which may be, for example, a web browser application, or an application downloaded from an application store or a website.

The application 130 includes a video player module 132. The video player module 132 includes instructions for implementing a video player in a user interface, such as a user interface presented on the display 126. The application 130 is executed by the processor 122 to present video content items in a video player implemented via the video player module 132, and supplemental content items as discussed further below, to the user of the user device 102 via the display 126 (and possibly one or more speakers of the user device 102, not shown in FIG. 1). In an implementation where the application 130 is a web browser application, for instance, the video player may be integrated in a web page, with the web browser causing the user device 102 to download HyperText Markup Language (HTML), scripts, and/or other code of the web page for presentation to a user via the display 126. As another example, the application 130 may be a video sharing application such as Google's YouTube®, and the video player may be integrated in a user interface generated by the video sharing application and presented via the display 126. In still other examples, the video player and the application 130 are one and the same (i.e., the application 130 is a dedicated video player application).

The display 126 includes hardware, firmware, and/or software configured to enable a user to view visual outputs of the user device 102, and may use any suitable display technology (e.g., LED, OLED, LCD, etc.). Moreover, in some implementations where the user device 102 is a wearable device, the display 126 is a transparent viewing component (e.g., lenses of smart glasses) with integrated electronic components. For example, the display 126 may include micro-LED or OLED electronics embedded in lenses of smart glasses.

The input device 128 is capable of receiving inputs from the ambient environment and/or a user, such as a keyboard, a mouse, buttons, keys, a microphone, etc. Further, the input device 128 may be integrated with the display 126 as a touch screen having both input and output capabilities.

The network interface 120 includes hardware, firmware, and/or software configured to enable the user device 102 to exchange electronic data with the computing system 104 via the network 110. For example, the network interface 120 may include a cellular communication transceiver, a WiFi transceiver, and/or transceivers for one or more other wired and/or wireless communication technologies.

While FIG. 1 shows the user device 102 as a single component communicating directly (i.e., via network 110) with the computing system 104, in some implementations the subcomponents of user device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The computing system 104 is generally configured to provide content to the user device 102, including video content items, via the network 110, and determine whether and how to present supplemental content items on the user device 102. The computing system 104 includes a network interface 140, a processor 142, and memory 144. The network interface 140 includes hardware, firmware, and/or software configured to enable the computing system 104 to exchange electronic data with the user device 102 and other, similar user devices via the network 110. For example, the network interface 140 may include a wired or wireless router and a modem. The processor 142 may be a single processor, or may include two or more processors. The computing system 104 may include one or more servers, for example, which may reside at a single location or multiple locations.

The memory 144 is a computer-readable, non-transitory storage unit or device, or collection of units/devices, that may include persistent and/or non-persistent memory components. The memory 144 stores the instructions of a content selector 152 and a presentation module 154, each of which may be executed by the processor 142. The content selector 152 includes a machine learning (ML) model 162. The presentation module 154 includes one or more ML models 164-166. In some implementations, some of the software modules/units shown in FIG. 1 are omitted. For example, the content selector 152 may omit the ML model 162, or the content selector 152 may be omitted in its entirety.

The modules 152 and 154 are software modules comprising instructions executed by the processor 142. The content selector module 152 is configured to select one or more supplemental content items, and the presentation module 154 is configured to determine whether the user device 102 is to present the selected supplemental content item(s) when a video content item presented by the video player 132 on the display 126 is paused (e.g., by the user). The selected supplemental content item(s) may be presented for any purpose. For example, a selected supplemental content item may be a digital advertisement (e.g., text, image(s), and/or video that advertise a product or service offered by an advertiser), and presentation of the supplemental content item may serve to promote a product or service associated with the advertisement. As another example, the selected supplemental content item may include one or more comments on the video content item being viewed by the user (e.g., past comments made by other viewers of the video content item). Presenting such comments when the video content item is paused may provide information of potential interest without disrupting the user's viewing experience. For ease of explanation, however, the examples provided herein refer primarily to implementations/scenarios in which each supplemental content item is a digital advertisement.

If the presentation module 154 determines that the user device 102 is to present supplemental content items (as described below), the processor 142 will generate a set of instructions and send the instructions to the user device 102, to cause the user device 102 to present at least one of the selected supplemental contents during a pause event.

In some implementations, and as discussed in further detail below, the content selector 152 selects the supplemental content items based on (i) one or more characteristics of a sponsor of one or more candidate supplemental content items, (ii) one or more characteristics of one or more candidate supplemental content items, (iii) one or more characteristics of the user, (iv) one or more behaviors of the user, and/or (v) one or more characteristics of the video content item.

In some implementations, the content selector 152 uses a ML model 162 to select supplemental content items. The ML model 162 is associated with a set of parameters. For example, in some implementations where the ML model 162 is a neural network that accepts one or more of the signals (i)-(v) above as inputs, the parameters may include weights associated with various nodes of the neural network, where the weights are set during a training process using a training data set. As another example, the ML model 162 may be a simpler scoring algorithm in which different weights are assigned to one or more of the signals (i)-(v) above. In either case, the training data set may include historical data indicative of any of the ML model 162 inputs (e.g., corresponding to one or more of the signals (i)-(v) above), and labeled with whatever prediction, classification, or other output that the ML model 162 is intended to produce (e.g., a score indicating a degree of relevance to the video content item the user is watching, an impression rate, a conversion rate, a quantified user experience, etc.). For example, if a goal is to optimize a conversion rate of the advertisements presented in connection with a particular video content item, the ML model 162 may be trained with historical data that is representative of indicative of any of the signals (i)-(v) above and labeled with corresponding conversion rates.

The set of parameters (e.g., neural network weights) may be iteratively updated when training the ML model 162 using the training data set. The updates may be based on a difference between an output produced using the training data and the label associated with the training data. For example, if the difference is more substantial, the changes to the parameters in an iteration/update may be greater. Once the ML model 162 is trained, the ML model 162 may be validated (using additional historical data) and then determined ready for run-time operation. After the ML model 162 is successfully trained and validated, in this example, it can predict a conversion rate for a set of supplemental content items to be presented in connection with a particular video content item. Based on the prediction, the processor 142 may select a set of supplemental content items, each of which is predicted to produce a highest conversion rate.

In some implementations, the content selector 152 predicts a supplemental content item to be presented to the user in a similar manner as it selects supplemental content item(s) described above.

The presentation module 154 determines whether and how to present supplemental content items.

In some implementations, the presentation module 154 determines whether to present supplemental content items based on signals related to presentation, including (i) one or more characteristics of a sponsor of one or more supplemental content items, (ii) one or more characteristics of one or more supplemental content items, (iii) one or more characteristics of the user, (iv) one or more behaviors of the user, (v) one or more characteristics of the video content item, (vi) a number limitation of supplemental content items, and/or other signals.

In some implementations, the presentation module 154 uses a first ML model 164 to determine whether to present supplemental content items. The first ML model 164 is associated with a set of parameters. For example, in some implementations where the first ML model 164 is a neural network that accepts one or more of the presentation-related signals (i)-(vi) above as inputs, the parameters may include weights associated with various nodes of the neural network, where the weights are set during a training process using a training data set. As another example, the first ML model 164 may be a simpler scoring algorithm in which different weights are assigned to one or more of the signals (i)-(vi) above. In either case, the training data set may include historical data indicative of any of the first ML model 164 inputs (e.g., corresponding to one or more of the signals (i)-(vi) above) labeled with whatever output that the first ML model 164 is intended to produce (e.g., an overall interest or tolerance of a user, an overall attention of a user, a quantified user experience, etc.). For example, if a goal is to predict a user's overall interest in viewing supplemental content items, the first ML model 164 may be trained with historical data that is representative of indicative of any of the signals (i)-(v) above and labeled with corresponding overall user interests.

The set of parameters (e.g., neural network weights) may be iteratively updated when training the first ML model 164 using the training data set. The updates may be based on a difference between an output produced using the training data and the label associated with the training data. For example, if the difference is more substantial, the changes to the parameters in an iteration/update may be greater. Once the first ML model 164 is trained, the first ML model 164 may be validated (using additional historical data) and then determined ready for run-time operation. After the first ML model 164 is successfully trained and validated, in this example, it can predict a user's interests in viewing a set of supplemental content items to be presented in connection with a particular video content item. If the predicted user interest is higher than a threshold, the processor 142 may determine to cause the user device 102 to present supplemental content items during a pause event.

In some implementations, the presentation module 154 determines a manner to

present supplemental content items. More specifically, the server may determine to (a) cause the user device 302 to reconfigure a video player responsive to an indication of a pause event and present supplemental content items in respective content slots proximate to the reconfigured video player, (b) cause the user device 302 to present supplemental content items in respective overlays on the video play, or (c) cause the user device 302 to present supplemental content items with a customized animation. In some implementations, the server determines certain aspects of how to present one or more supplemental content items, such as a temporal order of presenting the supplemental content items, sizes of the supplemental content items to be presented, elements and their respective sizes of the supplemental content items to be presented, etc, as described below.

The presentation module 154 determines a manner to present supplemental content items based on various signals, including (i) one or more characteristics of a sponsor of one or more supplemental content items, (ii) one or more characteristics of one or more supplemental content items, (iii) one or more characteristics of the user, (iv) one or more behaviors of the user, (v) one or more characteristics of the video content item, (vi) one or more characteristics of the user device, and/or other signals.

In some implementations, the presentation module 154 uses a second ML model 166 to determine how to present supplemental content items. The second ML model 166 is associated with a set of parameters. For example, in some implementations where the second ML model 166 is a neural network that accepts one or more of the presentation-manner-related signals (i)-(vi) above as inputs, the parameters may include weights associated with various nodes of the neural network, where the weights are set during a training process using a training data set. As another example, the second ML model 166 may be a simpler scoring algorithm in which different weights are assigned to one or more of the signals (i)-(vi) above. In either case, the training data set may include historical data indicative of any of the second ML model 166 inputs (e.g., corresponding to one or more of the signals (i)-(vi) above) labeled with a presentation manner and whatever output that the second ML model 166 is intended to produce (e.g., an impression rate, a conversion rate, a quantified user experience, etc.). For example, if a goal is to optimize a conversion rate of the advertisements presented in connection with a particular video content item, the second ML model 166 may be trained with data labeled with corresponding presentation manners and conversion rates.

The set of parameters (e.g., neural network weights) may be iteratively updated when training the second ML model 166 using the training data set. The updates may be based on a difference between an output produced using the training data and the label associated with the training data. For example, if the difference is more substantial, the changes to the parameters in an iteration/update may be greater. Once the second ML model 166 is trained, the second ML model 166 may be validated (using additional historical data) and then determined ready for run-time operation. After the second ML model 166 is successfully trained and validated, in this example, it can predict a conversion rate of a set of supplemental content items to be presented in a particular manner in connection with a particular video content item. The processor 142 may determine to cause the user device 102 to present the supplemental content items in accordance with a manner having a highest predicted conversion rate.

In the example implementation of FIG. 1, the computing system 104 is communicatively coupled with a supplemental content items database 172, a video content items database 174, and a user information database 180. Each of the databases 172, 174, and/or 180 may be stored in a local memory (e.g., the supplemental content items database 172 may be stored in the memory 144), or may be stored in memory remote from the coupled device/system (e.g., the supplemental content items database 172 may be stored in a memory remote from the computing system 104).

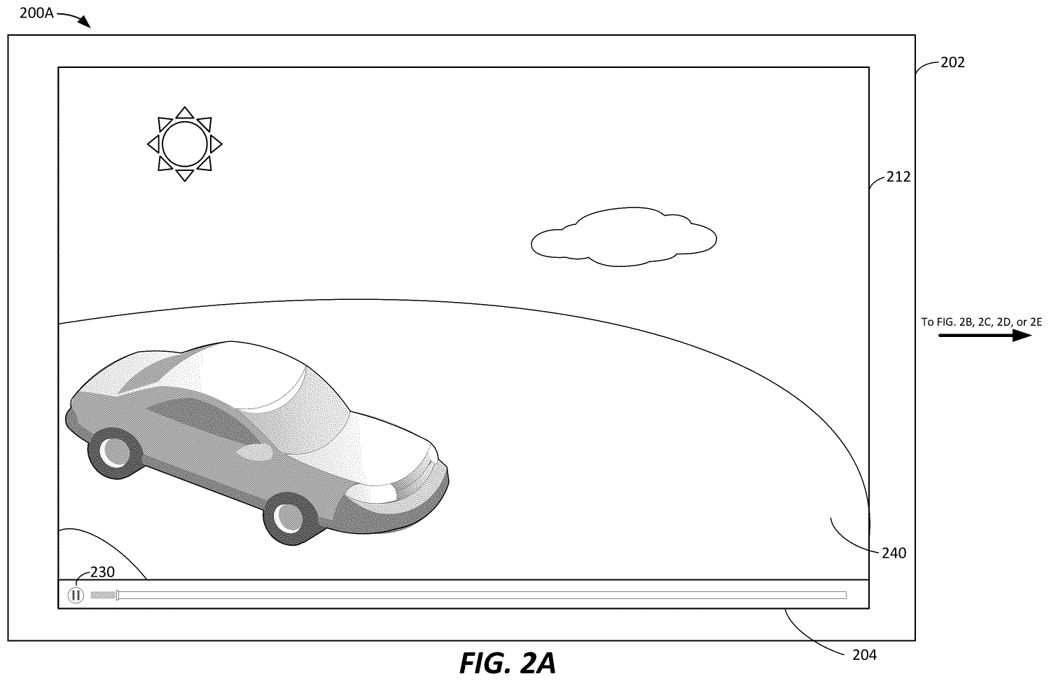

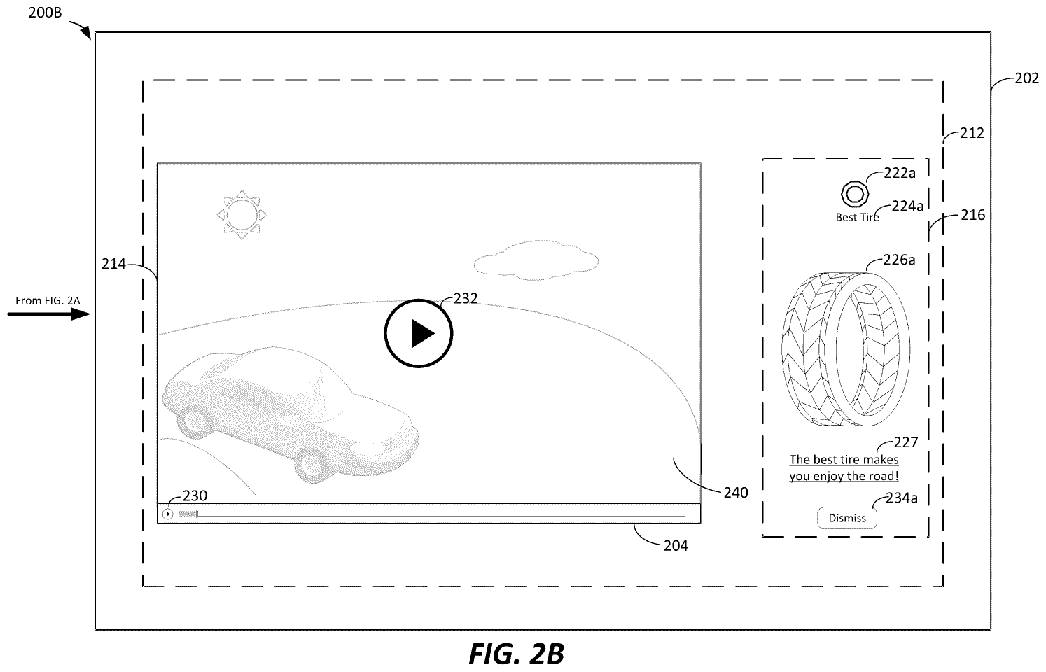

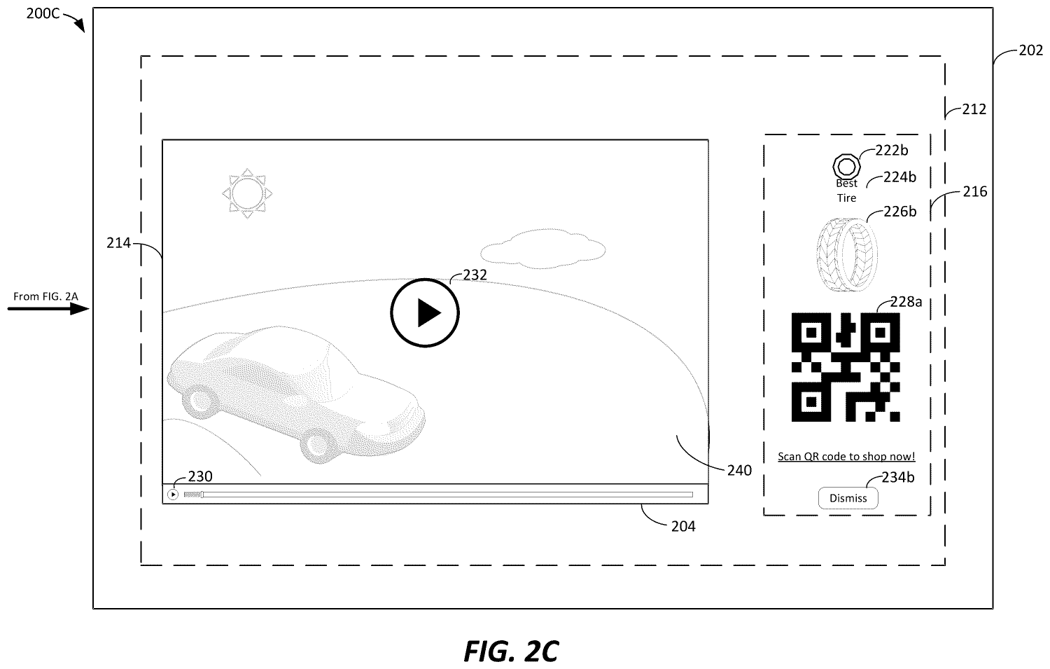

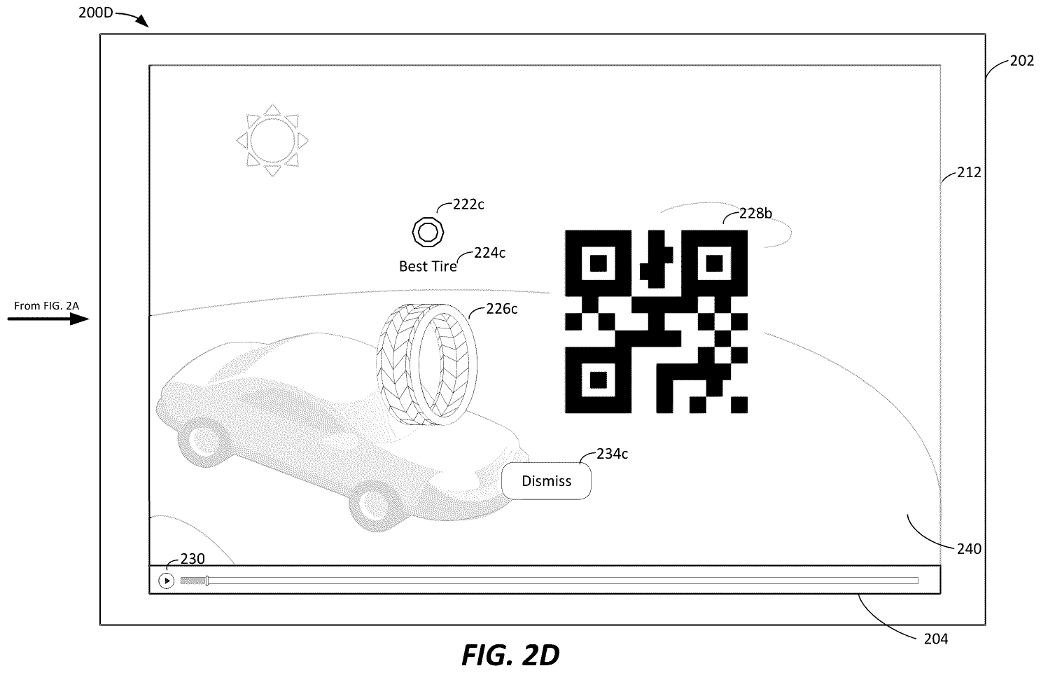

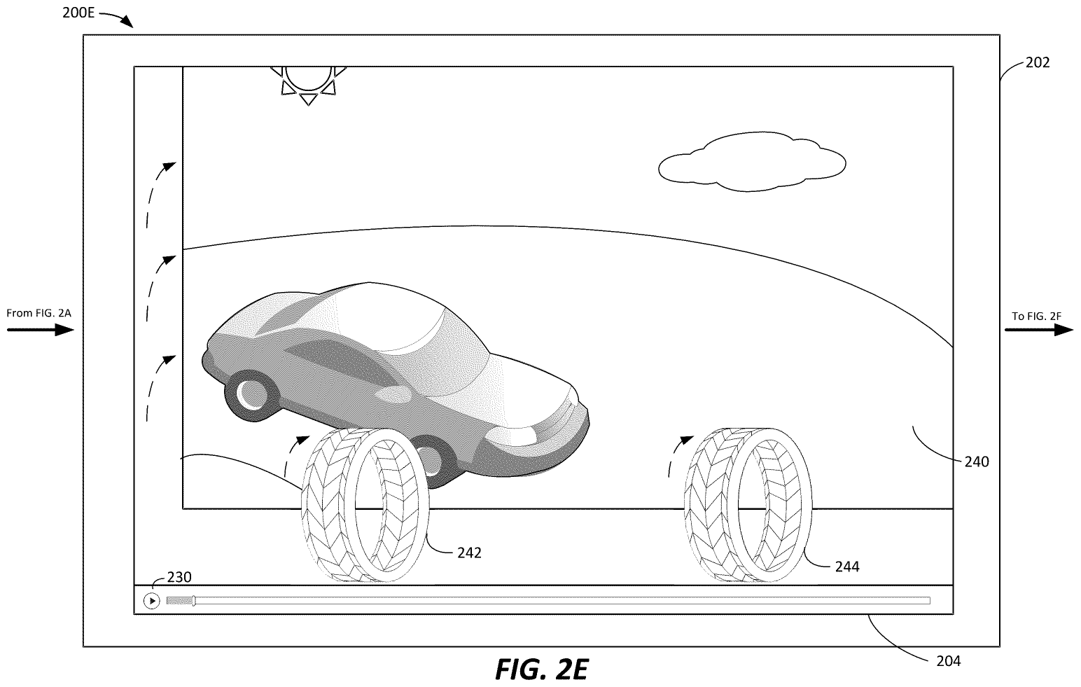

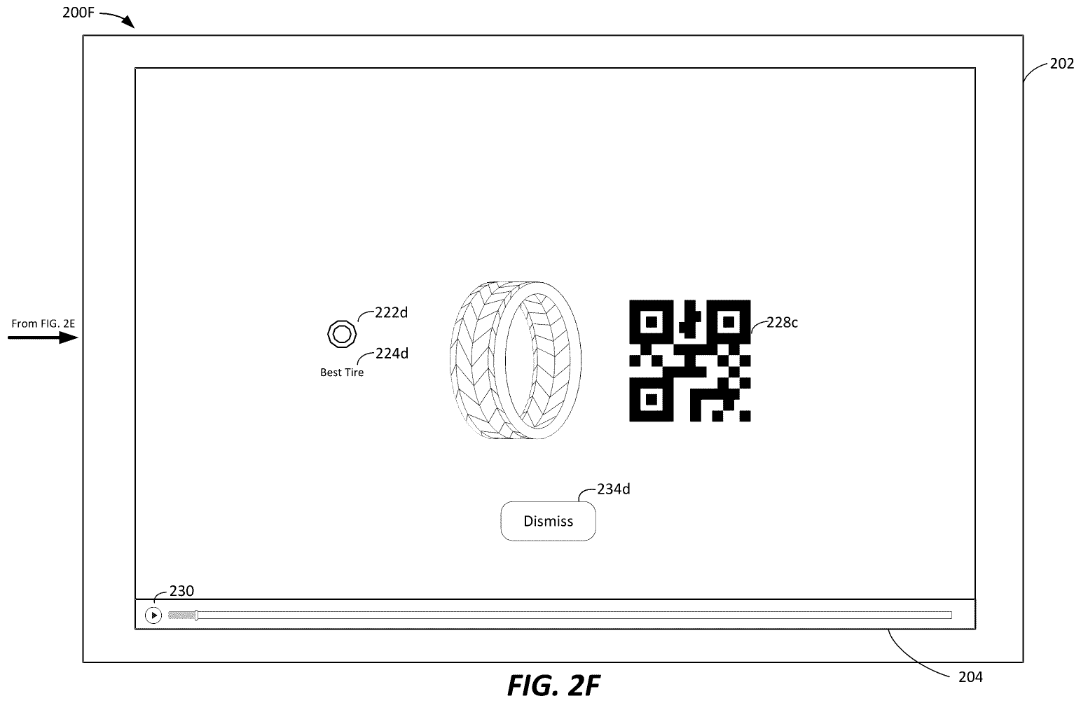

The supplemental content items database 172 includes advertisements and other content that supplements a video content item being watched. An advertisement may include text content, image content, audio content, and/or video content. The text content, image content, audio content, and/or video content may be integrated into an advertisement file such that after the user device 102 loads the advertisement file, the user device 102 may render the advertisement as it is. Alternatively, the image content, audio content, and/or video content may be organized with a set of instructions which, when executed by the user device 102, cause the user device to render the advertisement including the image content, audio content, and/or video content in a manner dictated by the set of instructions. In the latter scenario, the processor may adjust the sizes of the different contents (such as the elements 222a, 224a, bb6a, and 227 in FIG. 2B) and the order or manner to present the contents with the set of instructions.

The user information database 180 stores information associated with the user of user device 102, and the users of other similar devices, that the users previously agreed to share for use by the entity associated with the computing system 104. For example, the user information database 180 may store user location information, indications of video content items previously watched by users (e.g., URLs, categories, titles, etc.), indications of supplemental content items previously watched by users (products, services, etc.), user profiles (e.g., demographic information such as age, gender, etc.), and/or user preference information.

### Example User Interface

FIGS. 2A-2F depict example scenarios in which supplemental content items are presented with a paused video according to some implementations.

FIG. 2A depicts an exemplary graphical user interface (GUI) 200A presented on a display 202 (such as the display 126), according to some implementations of the techniques disclosed herein. The GUI 200A may be a GUI of a standalone application or a web-based application running on a user device (such as user device 102). The display 202 may be a portion of the user device or communicatively connected to the user device (e.g., via wires or an electronic network).

The GUI 200A includes a video player 204 arranged in a first region 212. As shown, a video content item 240 is being played in the video player 204. In some implementations, the first region 212 covers the entire displayable area of the display 202.

The GUI 200A includes a selectable element 230 configured to enable a user to pause or play the video content item 240. When the user device is playing the video content item, responsive to the user selects the selectable element 230, the user device receives an indication of a pause event for the video content item 240.

Turning to FIG. 2B, in some implementations, responsive to detecting an indication of a pause event (such as the user interacts with the selectable element 230), the user device (i) pauses the video content item, (ii) rearranges the video player 204 to be in a second region 214, and (iii) presents a supplemental content item in a content slot in a third region 216 of the display 202. The second region 214 is smaller than the first region 212. The third region 216 does not overlap the second region 214. In some implementations, the second region 214 overlaps the first region 212.

In some implementations, the supplemental content item is an advertisement associated with a product or a service of a sponsor. The advertisement may include a logo 222a, a brand name 224a, a picture 226a, and a slogan 227 associated with the product or service. When a user interacts with any of the elements 222a, 224a, 226a, and 227, the user device presents a shopping webpage of the product or service.

In some implementations, the GUI 200B includes a selectable element 232 configured to allow the user to resume the video content item. Responsive to detecting the user interacting (i.e., a user input) with the selectable element 232 or the selectable element 230, the user device removes the supplemental content item from the display 202, rearranges the video player 204 to be in the first region 212, and resumes the playing of the video content item 240.

In some implementations, the GUI 200B includes a selectable element 234a configured to allow the user to dismiss the supplemental content items. Responsive to detecting the user interacting (i.e., a user input) with the selectable element 234a, the user device removes the supplemental content item from the display 202, rearranges the video player 204 to be in the first region 212, and maintains the pause of the video content item 240.

FIG. 2C depicts a similar scenario as FIG. 2B, except that in FIG. 2C, the user device presents a supplemental content item with elements whose relative sizes are different from those in FIG. 2B. Further, the additional element includes a QR code configured to allow the user to shop by scanning.

Turning to FIG. 2D, in some implementations, responsive to detecting an indication of a pause event, the user device (i) pauses the video content item 240 and (ii) presents a supplemental content item in an overlay on the video player 204. In some implementations, the user device may apply a special effect to the video content item 240, such as adding a translucent layer above the video content item 240 or applying a halo effect to the video content item 240.

Turning to FIG. 2E, in some implementations, responsive to detecting an indication of a pause event, the user device (i) pauses the video content item and (ii) presents an indication of a supplemental content item with a customized animation. In the example scenario shown in FIG. 2E, the supplemental content item is an advertisement of a tire. When the user device detects an indication of a paused event, the user device presents two tires 242, 244 rolling from the left bottom of the display. The video content item 240 rolls from the left bottom along with the tires 242, 244. The video content item 240 then rolls from left to right with the tires 242, 244 as if the video content item were driven by the tires 242, 244 until they disappear from the video player 204.

Turning to FIG. 2F, after the video content item 240 disappears with the tires 242, 244 from the display 202, the user device presents the supplemental content item on the display 202.

In each of implementations described above, the user device may present more than one supplemental content items responsive to an indication of a pause event. The user device may present each of the supplemental content items in a respective content slot or overlay. Each of the content slots or overlays may be configured in a non-overlapping area.

### Example Process

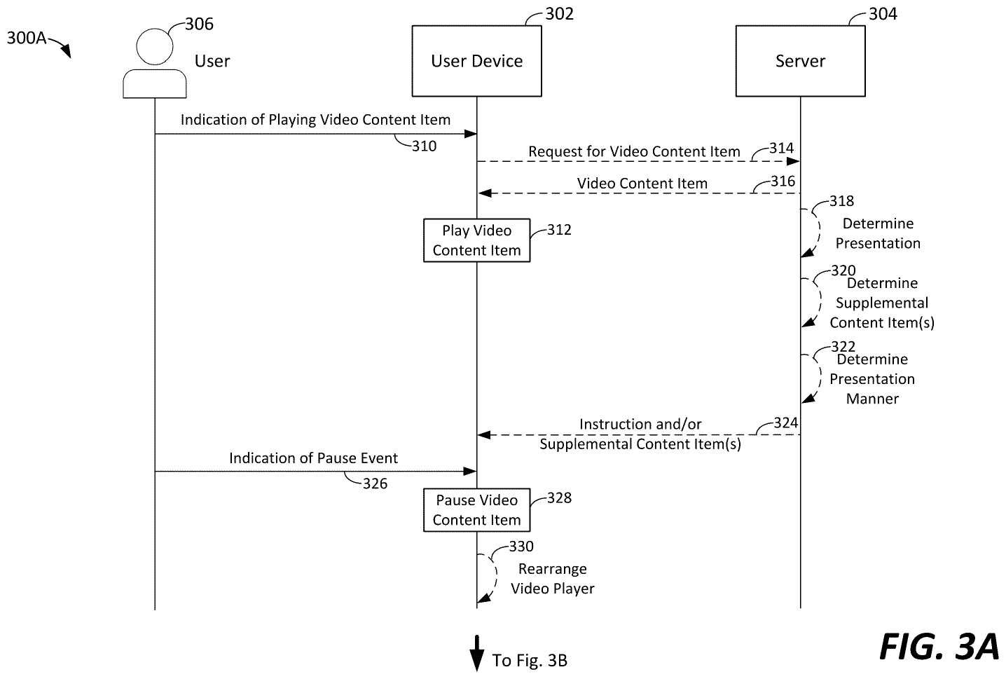

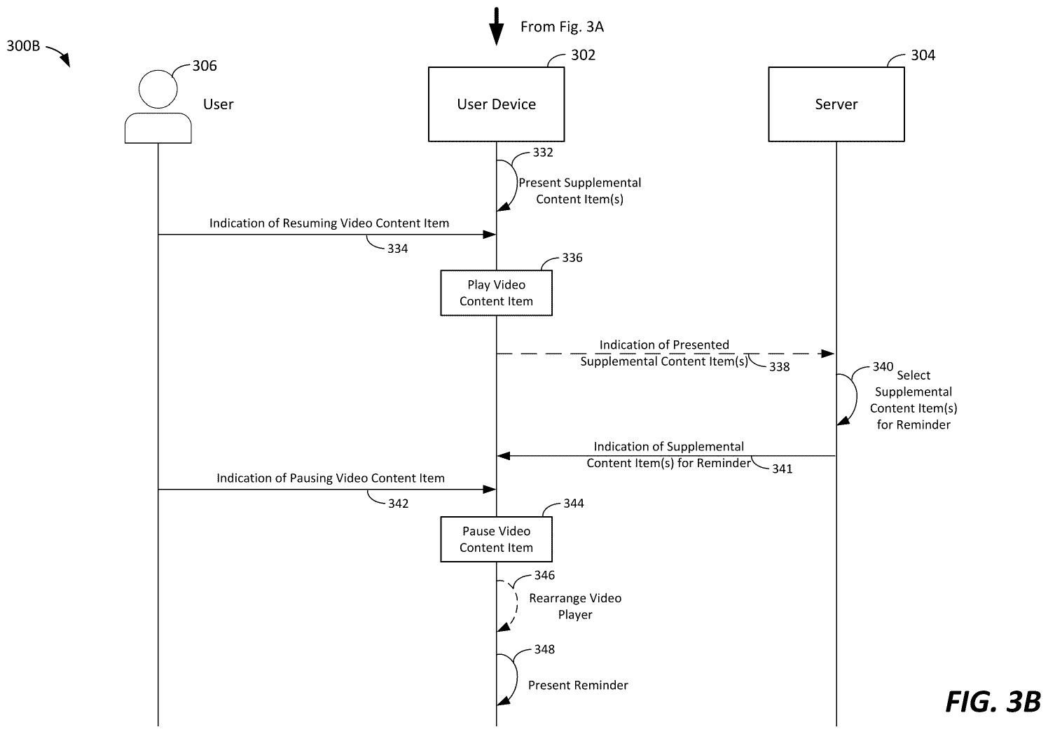

FIG. 3A depicts an example process 300A for presenting supplemental content items with a paused video content item according to one implementation.

The process 300A begins with a user 306 providing 310 to a user device 302 (such as the user device 102) an indication of playing video content (such as the video content item 240). The user 306 may provide 310 the indication via the input device 128 (e.g., by clicking on or otherwise selecting a displayed thumbnail, icon, or other element that represents the video content). In some implementations, responsive to detecting the indication of playing the video content, the user device 302 transmits 314 a request for the video content item to a server 304 (such as the computing system 104). Upon receiving 316 the video content item from the server 304, in response to the request of step 314, the user device 302 plays 312 the video content item in a video player (such as the video player 204) on a display (such as the display 126) associated with the user device 302. In other implementations, the user device 302 stores the video content item locally at an earlier time, and then, responsive to detecting the indication of playing the video content item, loads the video content item and plays 312 the video content item in the video player.

In some implementations, the server 304 determines 318 whether to present supplemental content items during a pause event of the video contents based on one or more signals. The one or more signals may include at least one signal indicative of user interest or attention, including at least one of (i) one or more characteristics of a sponsor of one or more supplemental content items, (ii) one or more characteristics of one or more supplemental content items, (iii) one or more characteristics of the user 306, (iv) one or more behaviors of the user 306, (v) one or more characteristics of the video content item, and/or other signals. For example, the server 304 may determine to cause the user device 302 to present supplemental content items during a pause event of the video contents if the server 304 detects that at least one of the signals (i)-(v) indicates the user's interests or attention to supplemental content items. The server 304 may determine whether to present supplemental content items using a trained machine learning model (such the first ML model 164). The machine learning model may use data indicative of signals (i)-(v) as input data.

Signals (i)-(v) are now discussed in more detail, with reference to various, non-limiting example implementations:
(i) One or more characteristics of a sponsor of one or more supplemental content items. An example characteristic of a sponsor is the relevance of the sponsor to the video content item the user 306 is viewing. For instance, a sponsor may be associated with the industry of tires. If the video content item shows a road trip (see signal (v) below), and/or if the profile of the user 306 shows that the user 306 is interested in road trips, the fact that the sponsor is in the tire industry (e.g., indicated by data associated with a supplemental content item) may indicate that the user 306 is relatively likely to be interested in viewing an advertisement for tires (i.e., the user device 302 should present such supplemental content item(s)). As another example, a characteristic of a sponsor of an addition content item is review information of the sponsor. For instance, if the sponsor receives positive online reviews, such review information may indicate that the user would be interested in viewing a supplemental content item associated with the sponsor.
(ii) One or more characteristics of one or more supplemental content items. Similar to the characteristic of a sponsor, example characteristics of a supplemental content item indicative of interest or attention of the user 306 may include the relevance of the supplemental content item to the video content item, and review information associated with the supplemental content item. Another example characteristic of a supplemental content item is a vertical associated with the supplemental content item. A “vertical” may be a business or service category associated with the supplemental content item, and may be indicated by one or more data labels associated with the supplemental content item. The data label(s) may include a search keyword associated with the supplemental content item, demographic information of an intended audience associated with the supplemental content item, etc. For example, a search keyword associated with a tire advertisement may be “tire,” “car,” “car accessories,” etc. When the user 306 searches for videos by entering the term “car,” the search keyword “car” associated with the tire advertisement may indicate that the user 306 would be interested in viewing the tire advertisement during a pause event of a video. As another example, the intended audience for a tire advertisement may be people having purchased an item for a vehicle (e.g., engine oil, wiper fluid, etc.). If the user's profile shows that the user 306 has purchased such an item, the intended audience information for the tire advertisement may indicate that the user 306 would be interested in viewing the tire advertisement.
(iii) One or more characteristics of the user 306. As described above, an example characteristic of a user is an interest indicated by a profile of the user 306. For instance, the user's address may indicate that the user would be interested in products and services provided close to the user's address. In another instance, the user's occupation may indicate that the user 306 would be interested in products or services that help the user's career. In yet another instance, the user's activity histories may indicate the user's interest in certain supplemental content items. If the user has watched a number of videos related to road trips, or has shopping records related to road trips (e.g., history of booking motels), these histories may indicate that the user is interested in road trips and is potentially interested in buying tires (or a maintenance check for the user's vehicle, etc.). Another example characteristic is the user's tolerance to supplemental content items (e.g., do not show supplemental content items if the user 306 would be irritated). The server 304 may estimate the user's tolerance based on the number of supplemental content items that the user has viewed in a particular time period, and/or information of the user's profile. The user's tolerance may be estimated using a ML model (such as the first ML model 164).
(iv) One or more behaviors of the user 306. For example, if, during a previous pause event, the user 306 had been inactive (e.g., does not interact with the GUI 200B) for a certain period of time, such a historical behavior may indicate that the user 306 is unlikely to pay attention to supplemental content items presented during a pause event. As another example, if, during a previous pause event, the user 306 interacted with a supplemental content item (e.g., clicks any of the elements 222a-227), such a historical behavior may indicate that the user 306 is likely to be interested in viewing supplemental content items presented during a pause event.
(v) One or more characteristics of the video content item. Similar to the description of signals (i) and (ii), the relevance of video content item to a supplemental content item and/or a sponsor associated with a supplemental content item may indicate the user's interest in viewing the supplemental content item. Another example characteristic of the video content item indicative of the user's interests or attention is a content type of the video content item. For instance, if the video content item is a reality show, the content type of the video content item (i.e., an entertaining video) may indicate that the user would not find a supplemental content item presented during a pause event to be intrusive, and thus would more likely be interested in viewing the supplemental content item. In another instance, if the video content item is a cooking show, the content type of the video content item (i.e., an informative video) may indicate that the user would not be interested in viewing supplemental content items during the pause event (e.g., the user may instead be pausing to take notes or research information about the ingredients being used).

In some implementations, to allow the server 304 to make the determination 318 based on signals that involve the supplemental content item(s) (e.g., the signals (i) and (ii) described above), the server 304 determines the supplemental content item(s) before making the determination 318 (e.g., as discussed below with reference to determination 320). In other implementations, the server 304 first determines one or more “candidate” supplemental content items (not shown in FIG. 3A), and then makes the determination 318 using one or more of the candidate supplemental content items. The server 304 may then determine 320 (e.g., selects) one or more supplemental content items from the candidate supplemental content item(s) after the determination 318.

In addition or alternative to the signal(s) indicative of the user's interests or attention, the server 304 may make the determination 318 based on other signals such as (i) an interest of a sponsor in at least one of the one or more supplemental content items, (ii) a number limitation of supplemental content items, and/or other signals.

Signals (i)-(ii) are now discussed in more detail, with reference to various, non-limiting example implementations:
(i) An interest of a sponsor in showing at least one of the one or more supplemental content items. For example, a sponsor's interest may be indicated by how a content slot of the supplemental content item was bought. More specifically, the sponsor may have a stronger interest in showing an advertisement in a content slot if the sponsor bought a placement opportunity in the content slot by bidding in an automated auction than if the sponsor bought the placement opportunity in a fixed-price sale. As another example, a sponsor's interest may be indicated by the price paid for the content slot. More specifically, the sponsor may have a stronger interest in showing the supplemental content item if the sponsor paid a higher price for the placement opportunity in the content slot.
(ii) A number limitation of supplemental content items. The server 304 may set a number limitation with respect to a particular video content item, a particular time period, a particular user, a particular product or service, a particular type of products or services, and/or a particular sponsor. For example, if the server 304 has set a number limitation with respect to a particular video content item, when the number of supplemental content items presented in connection with the particular video content has reached the number limitation, the server 304 will determine 318 not to present supplemental content items during a pause event. The server 304 may determine the number limitation based on at least one of (a) one or more characteristics of a sponsor of one or more supplemental content items, (b) one or more characteristics of one or more supplemental content items, (c) one or more characteristics of the user 306, (d) one or more behaviors of the user 306, (e) one or more characteristics of the video content item, and/or other signals. For example, if, based on the signals (a)-(e), the server 304 determines that the user 306 has a high tolerance to or interest in the supplemental content items to be presented, the server 304 will determine a high number limitation of supplemental content items.

In some implementations, the server 304 determines the one or more supplemental content items to be presented during a pause event. The server 304 may determine 320 the one or more supplemental content items based on (i) one or more characteristics of a sponsor of one or more candidate supplemental content items, (ii) one or more characteristics of one or more candidate supplemental content items, (iii) one or more characteristics of the user 306, (iv) one or more behaviors of the user 306, (v) one or more characteristics of the video content item, and/or other signals. The server 304 may determine that the user 306 would be interested in viewing a candidate supplemental content item in based on signals (i)-(iii) and (v) in a similar manner as described with respect to step 318. Regarding to signal (iv), if, for example, during a previous pause event, during a previous pause event, the user interacted with a supplemental content item (e.g., clicks any of the elements 222a-227) that is similar to a particular candidate supplemental content item (e.g., the supplemental content items are associated with the same sponsor, the same type of product or service, associated with the same vertical, etc.), such a historical behavior may indicate that the user 306 is likely to be interested in viewing the particular candidate supplemental content item.

In addition or alternative to the signal(s) indicative of the user's interests or attention, the server 304 may make the determination 320 based on other signals such as a number limitation of supplemental content items. As discussed above with respect to step 318, the server 304 may set a number limitation with respect to a particular video content item, a particular time period, a particular user, a particular product or service, a particular type of products or services, and/or a particular sponsor. For example, if the server 304 has set a number limitation with respect to a particular sponsor, when the number of supplemental content items associated with the particular sponsor presented to the user 306 in a certain period of time has reached the number limitation, the server 304 will determine 320 not to present supplemental content items associated with the particular sponsor during a pause event.

The one or more candidate supplemental content items may be retrieved from one or more respective sponsors or stored in a database associated with the server 304 (e.g., the database 172). In some implementations, the server 304 determines 320 the one or more supplemental content items to be presented during the pause event after the server 304 determines 318 to cause the user device 302 present supplemental content item(s). In other implementations, the server 304 may determine 320 one or more supplemental content items to be presented before determining 318 whether to present the one or more supplemental content items. The server 304 may use ML model (such as the ML model 162) to determine the one or more supplemental content items to be presented during a pause event.

In some implementations, the server 304 determines 322 a manner for presenting supplemental content items based on one or more signals. More specifically, the server 304 may determine 322 to (a) cause the user device 302 to reconfigure a video player responsive to an indication of a pause event and present supplemental content items in respective content slots proximate to the reconfigured video player (such as the scenarios depicted in FIG. 2B or FIG. 2C), (b) cause the user device 302 to present supplemental content items in respective overlays on the video play (such as the scenario depicted in FIG. 2D), or (c) cause the user device 302 to present supplemental content items with a customized animation (such as the scenario depicted in FIGS. 2E-2F). In some implementations, the server 304 determines 322 certain aspects of how to present one or more supplemental content items, such as a temporal order of presenting the supplemental content items, sizes of the supplemental content items to be presented, elements and their respective sizes of the supplemental content items to be presented, etc, as described below.

The one or more signals used in determination 322 may include at least one signal indicative of user interest or attention, including at least one of (i) one or more characteristics of a sponsor of one or more supplemental content items, (ii) one or more characteristics of one or more supplemental content items, (iii) one or more characteristics of the user 306, (iv) one or more behaviors of the user 306, (v) one or more characteristics of the video content item, and/or other signals, similar to the signals described with respect to step 318. For example, based on the signals (i)-(v), if the server 304 determines that the user's interest in supplemental content items is higher than a threshold, the server 304 determines to cause the user device 302 to present supplemental content in overlays without rearranging the video player. The server 304 may determine whether to present supplemental content items using a trained machine learning model. The machine learning model may use data indicative of signals (i)-(v) as input data.

In addition or alternative to the signal(s) indicative of the user's interests or attention, the server 304 may make the determination 322 based on other signals such as (i) an interest of a sponsor in at least one of the one or more supplemental content items, (ii) one or more characteristics of the user device 302, and/or other signals.

Signals (i)-(ii) are now discussed in more detail, with reference to various, non-limiting example implementations:
(i) An interest of a sponsor in showing at least one of the one or more supplemental content items. For example, a sponsor's interest may be indicated by the contract terms made when purchasing the placement opportunity in the content slot. More specifically, if the contract terms require the supplemental content item to be presented with a customized animation, the server 304 may determine to cause the user device 302 to present the supplemental content item accordingly.
(ii) One or more characteristics of the user device. An example characteristic of the user device is a device capability. For instance, if the user device 302 is capable of rearranging a video player, the server 304 will determine 318 to cause the user device 302 to, responsive to an indication of a pause event, rearrange the video player and present one or more supplemental content items in one or more respective content slots proximate to the rearranged video player (such as the scenarios shown in FIGS. 2B and 2C). In another instance, if the user device 302 is not capable of rearranging a video player, the server 304 will determine 318 to cause the user device 302 to, responsive to an indication of a pause event, present the one or more supplemental content items in one or more respective overlays on the video player (such as the scenario shown in FIG. 2D). Another example characteristic of the user device is a size of a display associated with the user device. If the size of the display is greater than a particular size threshold (e.g., 7.9 inches), the server 304 will determine 318 to cause the user device 302 to, responsive to an indication of a pause event, rearrange the video player and present one or more supplemental content items in one or more respective content slots proximate to the rearranged video player (such as the scenarios shown in FIGS. 2B and 2C). Otherwise, the server 304 will determine 318 to cause the user device 302 to, responsive to an indication of a pause event, present the one or more supplemental content items in one or more respective overlays on the video player (such as the scenario shown in FIG. 2D).

In the implementations where not all of the one or more supplemental content items are to be presented simultaneously, the server 304 determines 322 a temporal order for presenting the more the supplemental content items. The server 304 may determine the temporal order based on predicted user interests or attention, a price paid by a sponsor for presenting the supplemental content item, a contract with the sponsor of the supplemental content item, and/or other signals.

In some implementations where multiple supplemental content items are to be presented simultaneously, the server 304 determines 322 respective sizes for the respective content slots of the supplemental content items. The server 304 may determine the respective sizes based on (i) a number of the one or more supplemental content items to be displayed simultaneously with each other, (ii) one or more characteristics of a sponsor of at least one of the one or more supplemental content items, (iii) one or more characteristics of at least one of the one or more supplemental content items, (iv) one or more characteristics of a user of the user device, (v) one or more behaviors of the user, (vi) one or more characteristics of the user device, and/or one or more other signals. For example, when the number of supplemental content items to be presented simultaneously is relatively large, the server 304 may determine the sizes of each content slot to be relatively small. In another example, if the user device is associated with a larger display, the server 304 may determine the sizes of each content slot to be larger. In yet another example, if the server determines, based on any of signals (ii)-(v), that a user is likely to be more interested in a first supplemental content item than a second supplemental content item, the server 304 may determine a first content slot for the first supplemental content item to be bigger than a second content slot for the second supplemental content item. In yet another example, if a sponsor of a first supplemental content item pays more than a sponsor of a second supplemental content item, the server 304 may determine a first content slot for the first supplemental content item to be bigger than a second content slot for the second supplemental content item. In some implementations, the server 304 uses a ML model (such as the second ML model 166) to determine the sizes. In such implementations, the instruction transmitted at step 324 may indicate the determined sizes of the content slots to cause the user device 302 to present the supplemental content items accordingly.

In some implementations, the server 304 determines 322 what elements of a supplemental content item are to be presented and relative sizes of such elements (e.g., the elements 222a, 224a, 226a, and 227). For example, the server 304 may make the determination based on (i) one or more characteristics of a sponsor of one or more candidate supplemental content items, (ii) one or more characteristics of one or more candidate supplemental content items, (iii) one or more characteristics of the user 306, (iv) one or more behaviors of the user 306, and/or (v) one or more characteristics of the video content item. For example, if the user's online browsing history suggest that the user has not been exposed to the product or service of the supplemental content item, the server 304 may determine 322 (i) not to present a QR code and (ii) to present the product picture (such as element 226a) in a relatively big size to leave an impression on the user, as illustrated in FIG. 2B. In another example, if the product or service associated with the supplemental content item or the sponsor has been advertised widely, the server 304 may determine 322 the supplemental content item to include a conspicuous QR code (such as element 228a) to promote a quick conversion (e.g., the user scans the QR code to shop the advertised item), as illustrated in FIG. 2C.

The server 304 may perform the determination 322 after steps 318 and 320. Alternatively, the server 304 may perform the determination 322 before the step 320, in a similar manner as described with respect to step 318.

In some implementations, upon the server 304 determining 318 to cause the user device 302 to present supplemental content during a pause event, determining 320 the supplemental content item(s) to be presented, and/or determining 322 a manner of presenting the supplemental content item(s), the server 304 transmits 324 to the user device 302 a set of instructions for presenting one or more supplemental content items in accordance with the determined manner for presentation. The set of instructions may include indications of the one or more supplemental content items that allow the user device 302 to load the one or more content items stored on the user device 302. Alternatively, the set of instructions may include the content of the one or more supplemental content items that allow the user device 302 to load and present directly.

In some implementations, the steps 318 and 322 may be omitted. For example, the user device 302 is programmed to present one or more supplemental content items in a particular manner responsive to an indication of a pause event without further instructions from the server 304. As another example, the user device 302 determines 318 whether to present supplemental content item(s) and/or determines 322 the manner for presenting supplemental content item(s). In such implementations, the server 304 transmits 324 the one or more content items (either indications or contents as described above) to the user device 302 without the instructions for presenting the supplemental content item(s). In some implementations, the step 320 may be omitted. For example, a video content item may be associated with one or more supplemental content items before the user 306 requests to play the video content item. In the implementations where all of steps 318-322 are omitted, the step 324 may be omitted.

While playing 312 the video content item, the user 306 may provide 326 to the user device 302 an indication of a pause event. For example, an indication of a pause event may be the user 306 interacts a GUI element dedicated to pause a video content item (such as the user 306 selects the selectable element 230 via input device 128). As another example, an indication of a pause event may be the user 306 taking actions showing a lack of attention to the video content item (such as the user 306 opens a new window of the same application and requests to play another video content item). Responsive to detecting the indication of the pause event, the user device 302 pauses 328 the video content item.

In some implementations where the user device 302 is programmed to rearrange a video player, or the server 304 transmits 324 instructions for rearranging a video player, the user device 302 responds to event 326 by rearranging 330 the video player from a first region (such as the first region 212) on the display (such as the display 202) to be in a second region (such as the second region 214) on the display. The second region is smaller than the first region. In some instances, the second region overlaps with the first region. Turning to FIG. 3B, simultaneous with or after rearranging 330 the video player, the user device 302 presents 332 the one or more supplemental content items in respective one or more content slots in a third region (such as the third region 216). In some instances, the third region overlaps with the first region, but not the second region.

In some implementations, before rearranging the video player and presenting the supplemental content items, the user device 302 determines whether the supplemental content items to be presented have been loaded successfully. Alternatively, if a first supplemental content item or a first set of content items is to be presented before a second supplemental content item, the user device 302, before rearranging the video player and presenting the supplemental content items, determines whether the first supplemental content item or the first set of supplemental contents has been loaded successfully. Upon determining that the supplemental content items, the first supplemental content item, or the first set of supplemental content items has been loaded successfully, the user device 302 rearranges 330 the video player and presents 332 the one or more supplemental content items.

In some implementations where the user device 302 is configured to present supplemental content items in overlays, or the server 304 transmits 324 instructions to present supplemental content items in overlays, the user device 302 presents 332 the supplemental content item(s) in one or more respective overlays on the video player, such as the scenario illustrated in FIG. 2D. Similar to the implementations involving rearranging a video player (as described above), the user device 302 may present 332 the one or more supplemental content items only after determining that at least one of the one or more supplemental content items has been loaded successfully.

In some implementations where the user device 302 is configured to present a particular supplemental content item in a customized way, or the server 304 transmits 324 instructions for presenting a particular supplemental content item in a customized way, the user device 302 presents 332 the particular supplemental content item with a customized animation (e.g., the scenario illustrated in FIGS. 2E-2F). Similar to the implementations involving rearranging a video player (as described above), the user device 302 may present 332 the one or more supplemental content items only after determining that at least one of the one or more supplemental content items has been loaded successfully.

In some implementations, the server 304 causes the user device 302 to present a reminder of supplemental content item(s) that the user device 302 has previously displayed to the user 306. While pausing 328 the video content item, user 306 may provide 334 to the user device 302 an indication of resuming the video content item (e.g., the user 306 interacts with the selectable element 230 or 232). Responsive to detecting the indication of the resuming, the user device 302 resumes playing 336 the video content item.

In some implementations and/or scenarios, it is possible that at least one supplemental content item planned to be presented to the user 306 during a pause is not actually presented to the user 306. In some of these implementations, the user device 302 transmits 338 an indication of the supplemental content items that are actually presented during the pause event. An example of such implementations is where a first supplemental content item is planned to be presented before a second supplemental content during a pause event. The user 306 may dismiss the supplemental content items (such as by interacting with selectable element 232 or 234a-234d) before the user device 302 presents the second supplemental content item such that the second supplemental content item, although planned to be presented to the user, is not actually presented. Upon receiving the indication of the supplemental content items actually presented during the pause event, based on this indication and data associated with previous pause events and/or previously scheduled breaks, the server 304 selects 340 supplemental content item(s) presented during the pause event, previous pause events, and/or previously scheduled breaks.

In other implementations, based on the supplemental content items presented during the pause event, previous pause events and/or previously scheduled breaks, the server 304 selects 340 the at least one supplemental content item for the reminder from supplemental content items presented during the pause event, previous pause events, and/or previously scheduled breaks. In such implementations, the server 304 may select 340 the at least one supplemental content item before resuming 336 the video content item.

In some implementations, the server 304 selects 340 the last supplemental content item that the user viewed. In other implementations, the server 304 selects a set of multiple last-viewed supplemental content items. In yet other implementations, the server 304 selects 340 the at least one supplemental content item for the reminder based on at least one of (a) one or more characteristics of a sponsor of one or more supplemental content items, (b) one or more characteristics of one or more supplemental content items, (c) one or more characteristics of the user 306, (d) one or more behaviors of the user 306, or (e) one or more characteristics of the video content item. For example, if, based on the signals (a)-(e), the server 304 determines that the user is likely to be interested in a particular supplemental content item more than other supplemental content items, the server 304 will select 340 the particular supplemental content item. In another example, if, based on the signals (a)-(e), the server 304 determines that the user has least exposure to a particular supplemental content item, the server 304 will select 340 the particular supplemental content item. In yet another example, if a sponsor pays a high price for a particular supplemental content item, the server 304 will select 340 the particular content item.

Upon selecting the at least one supplemental content item, the server 304 transmits 341 an indication of the selected at least one supplemental content item. To this end, in some implementations, the server 304 replaces (i) an indication of a supplemental content item originally determined to be presented during a pause event with (ii) an indication of the selected supplemental content item. In the implementations where the user device 302 stores supplemental content items, the indication will allow the user device 302 to identify the selected supplemental content items from all the supplemental content items stored thereon and present it at the next pause event. In other implementations, the indication includes a content of the selected at least one supplemental content item, which allows the user device 302 to load and present the selected at least one supplemental content item at the next pause event.

While playing 336 the video content item, user 306 may provide 342 to the user device 302 an indication of a second pause event (e.g., the user 306 interacts with the selectable element 230). Responsive to detecting the indication of the second pause event, the user device 302 (i) pauses 344 the video content item, (ii) rearranges 346 the video player in some implementations, and (iii) presents 348 an indication of the selected at least one supplemental content item (i.e., a reminder). The indication of the at least one supplemental content item may be identical as the supplemental content item itself, that it, the indication is presented in an identical manner as how the selected at least one supplemental content item was presented during a previous pause event or a previously scheduled break event. Alternatively, the indication of the at least one supplemental content item may be different from the supplemental content item itself. For example, if the selected supplemental content item is presented in the manner depicted in FIG. 2B in a first pause event, an indication of the selected at least one supplemental content item may be presented in the manner depicted in FIG. 2C.

In some implementations, the server 304 determines (e.g., as part of the determination 320) a supplemental content to be presented in a future pause event or a future scheduled break event. Upon determining the supplemental content item, the server 304 causes the user device 302 to present an indication of the supplemental content item (i.e., a precursor of the supplemental content item). The precursor may be different from how the supplemental content will be presented in a future pause event or a future scheduled break event. For example, the indication may be a brand name associated with the supplemental content item presented on proximate to the video player.

In some implementations, the server 304 predicts a supplemental content item that is likely to be displayed to a user of the user device in a future pause event or a future scheduled break event. Upon predicting the supplemental content item, the server 304 causes the user device 302 to present an indication of the supplemental content item (i.e., a precursor of the supplemental content item) in one of the manners described above. The server 304 may make the prediction based on at least one of (i) one or more characteristics of a sponsor of one or more supplemental content items, (ii) one or more characteristics of one or more supplemental content items, (iii) one or more characteristics of the user 306, (iv) one or more behaviors of the user 306, or (v) one or more characteristics of the video content item. For example, if, based on the signals (i)-(v), the server 304 determines that the user is likely to interested in a particular supplemental content item, the server will determine that the particular supplemental content item is likely to be displayed to a user of the user device in a future pause event or a future scheduled break event. The server 304 may use a ML model (such as the ML model 162) to make the prediction.

In some implementations, the server 304 predicts a number of content slots to be presented in association with a particular video content item. The server 304 may make the prediction based on at least one of (i) one or more characteristics of the particular video content item, (ii) a relevance of a search vertical and the particular video content item, (iii) one or more characteristics of the user 306, (iv) one or more behaviors of the user 306, or (v) one or more characteristics of the user device. The server 304 may user a trained machine learning model to make the prediction.

Signals (i)-(v) are now discussed in more detail, with reference to various, non-limiting example implementations:
(i) One or more characteristics of the particular video content item. The server 304 may determine one or more past video content items that are similar to the particular video content item based on the one or more characteristics of the particular video content item. The server 304 may then predict a number of content slots associated with the particular video content item based on the number of supplemental content items presented in connection with each of one or more similar video content items. Relevant characteristics for determining similar video content items include a length of the particular video content item, an author of the particular video content item, a topic of the particular video content item, subscription information of an author of the particular video content item, and/or a content of the particular video content item.
(ii) A relevance of a search vertical and the particular video content item. The server 304 may determine a semantic relevance between the search vertical and a keyword associated with the particular video content item. The keyword associated with the particular video content item may be a word in the topic of the particular video content item, a text label associated with the particular video content item, and/or a comment associated with the particular video content item. The server 304 may predict the number of content slots associated with the particular video content to be big when the semantic relevance between the search vertical and a keyword of the particular video content item is high.
(iii) One or more characteristics of the user 306 and (iv) one or more behaviors of the user 306. For example, the server 304 may predict a number of content slots based on the number of supplemental content items that the user 306 usually views before the user 306 closes the video player. In another example, the server 304 may predict a number of content slots based on the number of pauses the user 306 usually takes before the user finishes a video content item. In some implementations, the server 304 makes the prediction based on one or more characteristics and one or more behaviors of an intended audience in a similar manner.
(v) One or more characteristics of the user device 302. For example, the server 304 may predict a number of content slots based on a size of a display associated with the user device 302. The server 304 may predict the content slots used at the same time to be smaller if the size of the display associated with the user device 302 is smaller. As another example, the server 304 may predict a user device capable of rearranging a video player to have more content slots.

In some implementations, the server 304 determines a price of a supplemental content item. The server 304 may determine the price based on at least one of (i) one or more characteristics of the supplemental content item, (iii) one or more characteristics of the user 306 or an intended audience, (iv) one or more characteristics of a campaign associated with the supplemental content item, (v) predicted benefits to a sponsor of the supplemental content item, (vi) a predicted cost to the user 306 or an intended user, or (vii) one or more characteristics of the user device 302 or user devices of an intended audience.

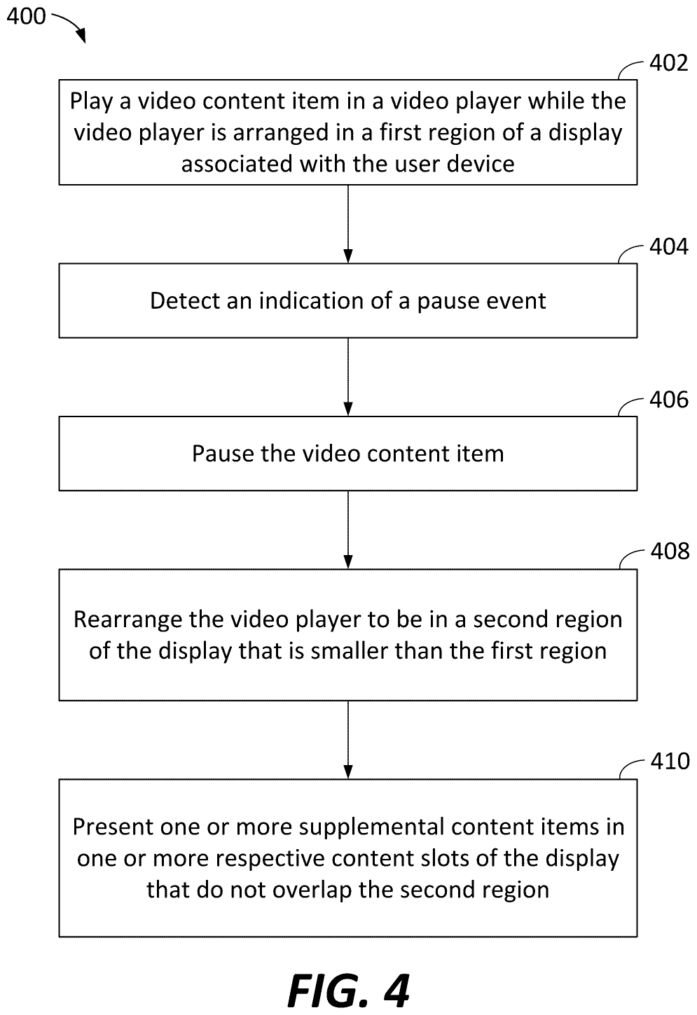

FIG. 4 is a flow diagram of an example method 400 for presenting supplemental content items with a paused video content item according to one implementation. At block 402, a user device (such as the user device 102) plays a video content item in a video player while the video player is arranged in a first region of a display associated with the user device, as described above with respect to step 312 of FIG. 3A. At block 404, the user device detects an indication of a pause event, as described above with respect to step 326. Responsive to detecting the indication of the pause event, at blocks 406-410, the user device (i) pauses the video content item, as described above with respect to step 328 of FIG. 3A, (ii) rearranges the video player to be in a second region of the display that is smaller than the first region, as described above with respect to step 330 of FIG. 3A, and (iii) presents one or more supplemental content items in one or more respective content slots of the display that do not overlap the second region, as described above with respect to step 332 of FIG. 3A. Although blocks 406-410 are depicted in a particular order in FIG. 4, blocks 406-410 may be performed in a different order or simultaneously. The method 400 may include additional or alternative steps described herein above.

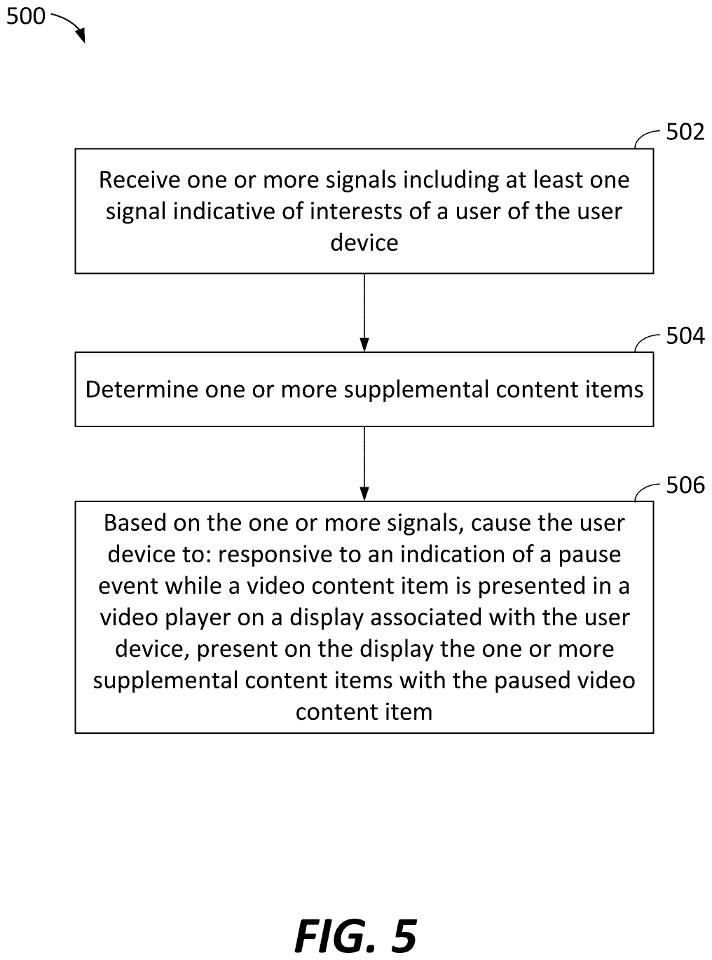

FIG. 5 is a flow diagram of an example method 500 for presenting supplemental content items with a paused video content item according to one implementation. At block 502, a server receives one or more signals including at least one signal indicative of interests of a user of the user device. At block 504, the server identifies one or more supplemental content items, as described above with respect to step 320 of FIG. 3A. At block 506, based on the one or more signals, cause the user device to, responsive to an indication of a pause event while a video content item is presented in a video player on a display associated with the user device, present on the display the one or more supplemental content items with the paused video content item, as described above with respect to steps 318 and 324 of FIG. 3A. The method 500 may include additional or alternative steps described herein above.

The following list of examples reflects a variety of the implementations explicitly contemplated by the present disclosure:

Example 1. A method, performed by a user device, for dynamic reconfiguration of a video player when pausing a video content item, the method comprising: playing the video content item in the video player while the video player is arranged in a first region of a display associated with the user device; detecting an indication of a pause event; responsive to the indication of the pause event, (i) pausing the video content item, (ii) rearranging the video player to be in a second region of the display that is smaller than the first region, and (iii) presenting one or more supplemental content items in one or more respective content slots of the display that do not overlap the second region.

Example 2. The method of example 1, wherein the one or more content slots overlap the first region.

Example 3. The method of example 1, further comprising: responsive to a user input, removing the one or more supplemental content items from the display, rearranging the video player to be in the first region, and resuming the playing of the video content item.

Example 4. The method of example 1, further comprising: responsive to a user input, removing the one or more supplemental content items from the display, rearranging the video player to be in the first region, and maintaining the pause of the video content item.

Example 5. The method of example 1, wherein rearranging the video player is responsive to the user device completing loading at least one of the one or more supplemental content items.

Example 6. The method of example 1, wherein the pause event is a first pause event, and wherein the method further comprises: responsive to a user input, resuming the playing of the video content item; and responsive to an indication of a second pause event, presenting the indication of a supplemental content item on the display, wherein the supplemental content item was presented on the display during the first pause event, a pause event before the first pause event, or a previous scheduled break event.

Example 7. A user device comprising: one or more processors; and a non-transitory memory storing executable instructions thereon that, when executed by the one or more processors, cause the one or more processors to perform the method of any one of examples 1-6.

Example 8. A method, performed by a server in communication with a user device via a network, the method comprising: receiving one or more signals including at least one signal indicative of interest or attention of a user of the user device; identifying one or more supplemental content items; and based on the one or more signals, causing the user device to: responsive to detecting an indication of a pause event while a video content item is presented in a video player on a display associated with the user device, present on the display the one or more supplemental content items with the paused video content item.

Example 9. The method of example 8, wherein detecting the indication of the pause event while the video player is arranged in a first region of the display, and wherein causing the user device to present the one or more supplemental content items with the paused video content item includes: causing the user device to, responsive to detecting the indication of the pause event while the video content item is presented on the display, (i) rearrange the video player to be in a second region of the display that is smaller than the first region, and (ii) present the one or more supplemental content items in one or more respective content slots of the display that do not overlap the second region.

Example 10. The method of example 9, further comprising: determining respective sizes for the one or more respective content slots, and wherein causing the user device to present the one or more supplemental content items in the one or more respective content slots is in accordance with the respective sizes.

Example 11. The method of example 10, wherein determining the respective sizes for the one or more respective content slots is based on at least one of: (i) a number of the one or more supplemental content items to be displayed simultaneously with each other, (ii) one or more characteristics of a sponsor of at least one of the one or more supplemental content items, (iii) one or more characteristics of at least one of the one or more supplemental content items, (iv) one or more characteristics of a user of the user device, (v) one or more behaviors of the user, or (vi) one or more characteristics of the user device.

Example 12. The method of example 8, wherein causing the user device to present the one or more supplemental content items with the paused video content item includes: causing the user device to, responsive to detecting the indication of the pause event while the video content item is presented on the display, present the one or more supplemental content items in one or more respective overlays on the video player.

Example 13. The method of example 8, wherein the at least one signal indicative of interest or attention of the user includes at least one of (i) one or more characteristics of a sponsor of at least one of the one or more supplemental content items, (ii) one or more characteristics of at least one of the one or more supplemental content items, (iii) one or more characteristics of a user of the user device, (iv) one or more behaviors of the user, or (v) one or more characteristics of the video content item.

Example 14. The method of example 8, wherein the one or more signals include at least one of (i) an interest of a sponsor in at least one of the one or more supplemental content items, (ii) a number limitation of supplemental content items, or (iii) one or more characteristics of the user device.

Example 15. The method of example 14, wherein the one or more signals include at least one signal based on the number limitation, and wherein the method further comprises determining the number limitation based on at least one of (i) one or more characteristics of a sponsor of one or more supplemental content items, (ii) one or more characteristics of one or more supplemental content items, (iii) one or more characteristics of the user, (iv) one or more behaviors of the user, or (v) one or more characteristics of the video content item.

Example 16. The method of example 8, wherein the pause event is a first pause event, the method further comprising: selecting a supplemental content item from supplemental content items that were displayed on the user device during the first pause event, a pause event before the first pause event, or a previous scheduled break event; and causing the user device to, responsive to detecting an indication of a second pause event, present an indication of the supplemental content item during the second pause event.

Example 17. The method of example 8, comprising: determining a supplemental content item to be presented in a future pause event or a future scheduled break event; and causing the user device to, responsive to detecting the indication of the pause event, present an indication of the supplemental content item.

Example 18. The method of example 8, comprising: predicting a supplemental content item that is likely to be displayed to a user of the user device in a future pause event or a future scheduled break event; and causing the user device to, responsive to detecting the indication of the pause event, display an indication of the supplemental content item.

Example 19. The method of example 18, wherein predicting the supplemental content item is based on at least one of (i) one or more characteristics of the user or (ii) one or more behaviors of the user.

Example 20. The method of example 8, further comprising: predicting a number of content slots to be presented in association with the video content item based on at least one of (i) on one or more characteristics of the video content item, (ii) a relevance of a search vertical and the video content item, (iii) one or more characteristics of a user of the user device, (iv) one or more behaviors of the user, or (v) one or more characteristics of the user device.

Example 21. A server in communication with a user device via a network, comprising: one or more processors; and a non-transitory memory storing executable instructions thereon that, when executed by the one or more processors, cause the one or more processors to perform the method of any one of examples 8-20.

Although the foregoing text sets forth a detailed description of numerous different aspects and implementations of the invention, it should be understood that the scope of the patent is defined by the words of the claims set forth at the end of this patent. The detailed description is to be construed as exemplary only.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method, performed by a server in communication with a user device via a network, the method comprising:
receiving one or more signals including at least one signal indicative of interest or attention of a user of the user device;
identifying one or more supplemental content items; and
based on the one or more signals, causing the user device to:
responsive to detecting an indication of a pause event while a video content item is presented in a video player on a display associated with the user device, present on the display the one or more supplemental content items with the paused video content item.

2. The method of claim 1, wherein detecting the indication of the pause event while the video player is arranged in a first region of the display, and wherein causing the user device to present the one or more supplemental content items with the paused video content item includes:
causing the user device to, responsive to detecting the indication of the pause event while the video content item is presented on the display, (i) rearrange the video player to be in a second region of the display that is smaller than the first region, and (ii) present the one or more supplemental content items in one or more respective content slots of the display that do not overlap the second region.

3. The method of claim 2, further comprising:
determining respective sizes for the one or more respective content slots, and wherein causing the user device to present the one or more supplemental content items in the one or more respective content slots is in accordance with the respective sizes.

4. The method of claim 3, wherein determining the respective sizes for the one or more respective content slots is based on at least one of: (i) a number of the one or more supplemental content items to be displayed simultaneously with each other, (ii) one or more characteristics of a sponsor of at least one of the one or more supplemental content items, (iii) one or more characteristics of at least one of the one or more supplemental content items, (iv) one or more characteristics of a user of the user device, (v) one or more behaviors of the user, or (vi) one or more characteristics of the user device.

5. The method of claim 1, wherein causing the user device to present the one or more supplemental content items with the paused video content item includes:
causing the user device to, responsive to detecting the indication of the pause event while the video content item is presented on the display, present the one or more supplemental content items in one or more respective overlays on the video player.

6. The method of claim 1, wherein the at least one signal indicative of interest or attention of the user includes at least one of (i) one or more characteristics of a sponsor of at least one of the one or more supplemental content items, (ii) one or more characteristics of at least one of the one or more supplemental content items, (iii) one or more characteristics of a user of the user device, (iv) one or more behaviors of the user, or (v) one or more characteristics of the video content item.

7. The method of claim 1, wherein the one or more signals include at least one of (i) an interest of a sponsor in at least one of the one or more supplemental content items, (ii) a number limitation of supplemental content items, or (iii) one or more characteristics of the user device.

8. The method of claim 7, wherein the one or more signals include at least one signal based on the number limitation, and wherein the method further comprises determining the number limitation based on at least one of (i) one or more characteristics of a sponsor of one or more supplemental content items, (ii) one or more characteristics of one or more supplemental content items, (iii) one or more characteristics of the user, (iv) one or more behaviors of the user, or (v) one or more characteristics of the video content item.

9. The method of claim 1, wherein the pause event is a first pause event, the method further comprising:
selecting a supplemental content item from supplemental content items that were displayed on the user device during the first pause event, a pause event before the first pause event, or a previous scheduled break event; and
causing the user device to, responsive to detecting an indication of a second pause event, present an indication of the supplemental content item during the second pause event.

10. The method of claim 1, comprising:
determining a supplemental content item to be presented in a future pause event or a future scheduled break event; and
causing the user device to, responsive to detecting the indication of the pause event, present an indication of the supplemental content item.

11. The method of claim 1, comprising:
predicting a supplemental content item that is likely to be displayed to a user of the user device in a future pause event or a future scheduled break event; and
causing the user device to, responsive to detecting the indication of the pause event, display an indication of the supplemental content item.

12. The method of claim 11, wherein predicting the supplemental content item is based on at least one of (i) one or more characteristics of the user or (ii) one or more behaviors of the user.

13. The method of claim 1, further comprising:
predicting a number of content slots to be presented in association with the video content item based on at least one of (i) on one or more characteristics of the video content item, (ii) a relevance of a search vertical and the video content item, (iii) one or more characteristics of a user of the user device, (iv) one or more behaviors of the user, or (v) one or more characteristics of the user device.

14. A server in communication with a user device via a network, comprising:
one or more processors; and
a non-transitory memory storing executable instructions thereon that, when executed by the one or more processors, cause the one or more processors to perform operations comprising:
receiving one or more signals including at least one signal indicative of interest or attention of a user of the user device;
identifying one or more supplemental content items; and
based on the one or more signals, causing the user device to:
responsive to detecting an indication of a pause event while a video content item is presented in a video player on a display associated with the user device, present on the display the one or more supplemental content items with the paused video content item.

15. The server of claim 14, wherein detecting the indication of the pause event while the video player is arranged in a first region of the display, and wherein causing the user device to present the one or more supplemental content items with the paused video content item includes:
causing the user device to, responsive to detecting the indication of the pause event while the video content item is presented on the display, (i) rearrange the video player to be in a second region of the display that is smaller than the first region, and (ii) present the one or more supplemental content items in one or more respective content slots of the display that do not overlap the second region.

16. The server of claim 15, wherein the operations further comprise:
determining respective sizes for the one or more respective content slots, and wherein causing the user device to present the one or more supplemental content items in the one or more respective content slots is in accordance with the respective sizes.

17. The server of claim 14, wherein causing the user device to present the one or more supplemental content items with the paused video content item includes:
causing the user device to, responsive to detecting the indication of the pause event while the video content item is presented on the display, present the one or more supplemental content items in one or more respective overlays on the video player.

18. The server of claim 14, wherein the pause event is a first pause event, and wherein the operations further comprise:
selecting a supplemental content item from supplemental content items that were displayed on the user device during the first pause event, a pause event before the first pause event, or a previous scheduled break event; and
causing the user device to, responsive to detecting an indication of a second pause event, present an indication of the supplemental content item during the second pause event.

19. The server of claim 14, wherein the operations comprise:
determining a supplemental content item to be presented in a future pause event or a future scheduled break event; and
causing the user device to, responsive to detecting the indication of the pause event, present an indication of the supplemental content item.

20. The server of claim 14, wherein the operations comprise:
predicting a supplemental content item that is likely to be displayed to a user of the user device in a future pause event or a future scheduled break event; and
causing the user device to, responsive to detecting the indication of the pause event, display an indication of the supplemental content item.
